(19) United States
(12) Patent Application Publication
(10) Pub. No.: US 2009/0224173 A1
(43) Pub. Date: Sep. 10, 2009

(54) Grating waveguide structure for reinforcing an excitation field and use thereof

(76) Inventors: Gert Ludwig Duveneck, Bad Krozingen (DE); Martin Andreas Bopp, Basel (CH); Michael Pawlak, Laufenburg (DE); Markus Ehrat, Magden (CH); Gerd Marowsky, Gottingen (DE)

Correspondence Address: WENDEROTH, LIND & PONACK, L.L.P., 1030 15th Street, N.W.,, Suite 400 East, Washington, DC, 20005-1503, US

(21) Appl. No.: 12/318,568

(22) Filed: Dec. 31, 2008

Related U.S. Application Data
(62) Division of application No. 10/257,036, filed on Oct. 8, 2002, now abandoned.

(30) Foreign Application Priority Data
Apr. 14, 2000 (CH) 742/00

(51) Int. Cl. G01J 1/58; G02F 1/01

(52) U.S. Cl. 250/459.1; 359/341.1; 250/227.11

(57) ABSTRACT

The invention relates to a variable embodiment of a grating waveguide structure, based on a planar thin-film waveguide with a first optically transparent layer (a) on a second optically transparent layer (b) having a lower refractive index than layer (a), and a grating structure (c) modulated in layer (a), wherein the intensity of an excitation light irradiated at the resonance angle for incoupling into layer (a) is enhanced by at least a factor of 100 on layer (a) and within layer (a), at least in the region of the grating structure (c), in comparison with the intensity of said excitation light on a substrate surface without incoupling of the excitation light. The invention also relates to an optical system with an excitation light source and an embodiment of a grating waveguide structure according to the invention, and to a method for enhancing an excitation light intensity, and to the use thereof in bioanalytical detection processes, in non-linear optics or in telecommunications or communications industry.

The invention relates to a variable embodiment of a grating waveguide structure, based on a planar thin-film waveguide with a first optically transparent layer (a) on a second optically transparent layer (b) having a lower refractive index than layer (a), and a grating structure (c) modulated in layer (a), wherein the intensity of an excitation light irradiated at the resonance angle for incoupling into layer (a) is enhanced by at least a factor of 100 on layer (a) and within layer (a), at least in the region of the grating structure (c), in comparison with the intensity of said excitation light on a substrate surface without incoupling of the excitation light. The invention also relates to an optical system with an excitation light source and an embodiment of a grating waveguide structure according to the invention, and to a method for enhancing an excitation light intensity, and to the use thereof in bioanalytical detection processes, in non-linear optics or in telecommunications or communications industry.

The goal of this invention is to provide optical structures and easily usable optical methods for achieving a large amplification of an excitation light field in the near-field of the grating waveguide structure, i.e., on said structure or at a distance of less than about 200 nm.

The use of gratings as diffractive components in optics has been described in many publications and been realized in technical components based thereon. For example, the well-known grating monochromators, as a part of spectrometers, are based on the deviation of an irradiated polychromatic light bundle into different spatial directions, dependent on the wavelength. Grating structures have found increased application in modern optics, since the techniques for the manufacture of highly precise gratings, especially with very short periods, e.g. of well below 400 nm, have been improved more and more. Examples of fields of applications are integrated optics, quantum electronics, telecommunications using optical data transmission, for example for optical switches or distributors, etc. Thereby, grating structures in combination with dielectric waveguides or metals, which can be used for generating anomali of the diffraction or of the reflectivity, are of special interest. Already Wood described the observation of an unusual reflectivity in 1902 (R W. Wood, “On a remarkable case of uneven distribution of light in a diffraction grating spectrum”, Phil. Mag. Vol. 4 (1902) 396-402), and Hessel and Oliner explained these anomalies by the generation of surface waves in metallic grating structures (A. Hessel and A. A. Oliner, “A new theory of Wood's anomalies”, Appl. Optics vol. 4 (1965) 1275-1297).

Especially in case of an optical waveguide, an almost complete disappearance of the transmitted light and an increase of the fraction of light radiated in direction of the reflection up to almost 100% can be observed, upon adequate choice of the parameters (for example grating period and grating depth, thickness of the optically transparent layer (a) of an optical waveguide, as well as its refractive index and the refractive indices of the adjacent media). The physical conditions for the disappearance of the transmission light and the simultaneous appearance of an irregular “reflection” (as the sum of regular fraction of reflection, following the radiation laws, and of the light out-coupled by grating structure) are, for example described and explained in D. Rosenblatt et al., “Resonant Grating Waveguide Structures”, IEEE Journal of Quantum Electronics, Vol. 33 (1997) 2038-2059. In all these works, however, only the fractions of the transmitted or reflected light, that are available and observed in the far-field of the grating structure, are described and explained by physical models. There are no hints at the distribution of the electromagnetic field strength or intensity on the surface of the structure.

On the other side, for example in biochemical analytics there is a strong need for arrangements and methods, which allow to detect with high selectivity and sensitivity an analyte in a supplied sample, using surface-immobilized biochemical or biological or synthetic recognition elements. Thereby, many known methods are based on the detection of one or more luminescences in presence of the analyte.

Thereby in this application, with the term “luminescence” is called the spontaneous emission of photons in the ultra-violet to infra-red spectral range, after optical or non-optical, such as electrical or chemical or biochemical or thermal excitation. For example, chemiluminescence, bioluminescence, electroluminescence and especially fluorescence and phosphorescence are included in the term “luminescence”.

In the following, the term “optical transparency of a material” is used in the sense that transparency of that material is required at least of an excitation wavelength. At a shorter or longer wavelength, this material can also be absorbent.

Sensitivity could be enhanced significantly in the last years by means of highly refractive thin-film waveguides, based on an only a few hundred nanometers thin waveguiding film. For example, in WO 95/33197 a method is described, wherein the excitation light is coupled into the waveguiding film using a relief grating as a diffractive optical element. The surface of the sensor platform is brought into contact with a sample containing the analyte, and the isotropically emitted luminescence from substances capable of luminescence and located within the penetration depth of the evanescent field is recorded by adequate measurement devices, such as photodiodes, photomultipliers or CCD-cameras. It is also possible to couple out, by a diffractive optical element such as a grating, and measure the fraction of evanescently excited luminescence, that has been coupled back into the waveguide. This method has been described, for example, in WO 95/33198.

In the following, the terms “evanescent field” and “near-field” are used synonymously.

It is a disadvantage of methods for the detection of evanescently excited luminescence described above in the state-of-the-art, especially in WO 95/33197 and WO 33/198, that always only one sample can be analyzed on the waveguiding layer, provided as a homogeneous film, of the sensor platform. In order to enable further measurements on the same sensor platform, tedious washing and cleaning steps are continuously required. This applies especially, if another analyte than in the first measurement shall be determined. In case of an immunoassay, this typically means that the whole immobilized layer on the sensor platform has to be exchanged, or that a new sensor platform as a whole has to be used anyhow.

Therefore, there is also a need for the development of a method allowing to analyze several samples in parallel, i.e. simultaneously or immediately one after the other, without additional cleaning steps.

For the simultaneous or sequential performance of multiple measurements exclusively based on luminescence detection, using essentially monomodal, planar anorganic waveguides, for example in WO 96/35940 devices (arrays) have been reported, wherein at least two discrete waveguiding regions are arranged on one sensor platform, which are irradiated separate from one another with excitation light. As a disadvantageous consequence of the segregation of the sensor platform into separate waveguiding areas, however, the area requirements for discrete measurement areas, in discrete waveguiding regions on the common sensor platform, is relatively large, and therefore, again, only a relatively small density of different measurement fields (or so-called “features”) can be achieved.

Therefore, there is also a need for an increase of the feature density or for a decrease of the required area per measurement area, respectively.

Based on simple glass or microscope slides, without additional waveguiding layers, arrays with a very high feature density are known. For example in U.S. Pat. No. 5,445,934 (Affymax Technologies) arrays of oligonucleotides with a density of more than 1000 features on a square centimeter are described and claimed. The excitation and read-out of such arrays is based on classical optical arrangements and methods. The whole array can be illuminated simultaneously, using an expanded excitation light bundle, which, however, results in a relatively low sensitivity, the portion of scattered light being relatively large and scattered light or background fluorescence light from the glass substrate being also generated in those regions, where no oligonucleotides for binding of the analyte are immobilized. In order to limit excitation and detection to the regions of immobilized features and to suppress light generation in the adjacent regions, there is widespread use of confocal measurement arrangements, and the different features are analyzed sequentially by scanning. The consequences, however, are an increased amount of time for the read-out of a large array and a relatively complex optical set-up.

Therefore, there is a need for an embodiment of the sensor platform and for an optical arrangement that allow for achieving a sensitivity as high as it has been achieved with sensor platforms based on thin-film waveguides and for minimizing simultaneously the required measurement area per feature.

In a co-pendent application (PCT/EP 00/04869), a sensor platform with a film waveguide, comprising an optically transparent layer (a) on a second layer (b) with lower refractive index than layer (a) and a grating structure (c) modulated in layer (a), with measurement areas provided thereon, is described. Thereby, the luminescence light back-coupled into layer (a), after incoupling of excitation light to the measurement areas and associated luminescence excitation in the near-field of layer (a), can be outcoupled completely over shortest distances, i.e. some hundred micrometers, upon adequate choice of the parameters, especially of the grating depth, und thus be prevented from further spreading in the waveguiding layer (a).

This arrangement allows for a highly sensitive, simultaneous determination of a multitude of analytes on a very small area. Upon optimization of the paths of rays and masking against reflections or scattered light, the sensitivity can be further increased. Finally however, the background signals and the associated noise of the background remain limiting. Besides others, this is caused by the fact that, for most applied luminescence dyes, the spectral separation between excitation end emission wavelength (Stokes shift) is relatively small, typically between 20 nm and 50 nm. Although some luminescence dyes exhibiting a large Stokes shift, up to 300 nm, are known, these dyes generally have, as a disadvantage, a relatively small quantum yield and/or photo stability.

Additionally, it is a disadvantage of the known arrangements based on highly refractive thin-fil waveguides, for example based on waveguiding films of Ta₂O₅ or TiO₂, combined with conventional excitation, that the propagation losses of these waveguides as well as the autofluorescence of these thin-film waveguides (for example caused by traces of fluorescent contaminations in layer (b)) increase drastically at short excitation wavelengths. Consequently, short-wavelength excitation is limited to about 450 nm to 500 nm. However, an arrangement would be appreciated, which would allow for exciting fluorophores also at shorter wavelengths and for detecting their luminescences with a background as low as possible or even without background, at best.

Recently methods have been reported which allow for almost background-free luminescence detection and are based on two-photon excitation. However, a two-photon excitation requires extremely high field strengths respectively intensities of the excitation light. In the described arrangements, this is achieved with powerful pulsed lasers with extremely short pulse durations (typically femto seconds). However, these optical arrangements are characterized by very high system costs, and they impose high requirements on the specific qualification of the users. In a very early work, in U.S. Pat. No. 3,572,941 from 1967, concerning the development of arrangements for reproduction and storage of three-dimensional images, it is described that, for example, for the (permanent) change of the optical density of a storage medium, such as a single-crystal, e.g. CaF₂ doted with La, excitation intensity densities of the order of 20·MW/cm² are required. Such high intensity densities have for example been achieved and described using pulsed high-power lasers in confocal microscopic arrangements, for example in U.S. Pat. No. 5,034,613 with a diameter of the laser focus below one micrometer in the focal plane of the microscope. The measurement of an extended area by scanning, however, requires a large investment in time, besides the high instrumental effort.

It has now been found surprisingly, that, upon adequate choice of the physical parameters of a grating waveguide structure and upon irradiation of the excitation light approximating the resonance angle for incoupling of the excitation light into the waveguiding layer (a) of the structure, an amplification of the excitation light by more than three decades can be achieved in the near-field of this structure, i.e. at a distance of less than 200 nm. An even larger amplification factor is reached within the waveguiding layer (a).

Surprisingly, for example the necessary field strength for a two-photon excitation in the near-field of the structure can be reached without larger technical effort, using a structure according to the invention.

Due to the very high, surface-confined excitation light intensities, that can be achieved with relatively small effort even for relatively low irradiated excitation light intensities, because of the very large amplification factors, grating waveguide structures according to the invention are suited for application in a variety of different technical fields. Besides the determination of the binding of an analyte to recognition elements immobilized on a surface, in bioanalytics, communication technique is another important field of application. Along with the always increasing requirements on the speed of data transfer, the degree of system networking, and the amount of data to be transferred, signal transfer by optical methods becomes more and more important. There is especially a high need for the capability to also switch optically the data that have been transferred optically. Currently used systems first have to transfer the optical signals into electrical signals. These electrical signals are then switched electrically and then again transferred into optical signals. This requires high technical efforts and is additionally associated with significant losses of the speed of data transfer.

First proposals for the purely optical switching of data have been made in different scientific publications. Therefore, a waveguide of a material with high third-order nonlinearity is used. Such materials with high third-order nonlinearities especially comprise polymers, such as poly diacetylene (n=1.59), poly toluenesulfonate (n=1.88), and poly phenylenevinylene (n=2.0). Characteristic for such a material, its refractive index changes in the presence of high electromagnetic field strengths. In the waveguide, a grating in from of a “Bragg grating” is structured. This is characterized in that it is reflective for certain wavelengths of light guided in the waveguide and transmissive for other wavelengths. For application as optical switches, the mentioned waveguides and associated gratings are designed in such a way, that a guided optical signal (light pulse) emanating from a nonstructured region of the waveguide is transmitted by the grating structure, i.e. is further guided beyond the grating structure, in direction of its propagation, in the uneffected (in absence of a switching signal). If, however, a second pulse of very high intensity, as a so-called “switching pulse”, arrives simultaneously with the signal pulse at the Bragg grating, the optical properties of this grating structure change in such a way that the signal pulse is reflected, due to the third-order nonlinearity (see for example C. M. de. Sterke und J. E. Sipe, “Switching dynamics of finite periodic nonlinear media: A numerical study”, Phys. Rev. A, Vol. 42, No, 5, 2858-2869 (1990) und N. D. Sankey et al. “All-optical switching in a nonlinear periodic-waveguide structure”, Appl. Phys. Lett. 60(12), 1427-1429, (1992)).

In case of these described methods, the switching pulse is guided in the same waveguide as the signal pulse, and therefore it must be incoupled and outcoupled by additional means.

In contrast, by means of an embodiment of the grating waveguide structure with a Bragg grating as grating structure (c) and a material of high third-order linearity for the optically transparent, waveguiding layer (a), the switching effect can surprisingly be achieved already at significantly lower intensities of the switching pulse in the resonance case, due to the strong increase of the field strength also in the waveguide (a). This new embodiment of an optical switch according to the invention has additionally the advantage, that an additional incoupling, guiding in the waveguide and final outcoupling of the switching pulse at a different region on the structure is not required.

First subject of the invention is a grating waveguide structure, comprising a planar thin-film waveguide, with a layer (a), transparent at least at one excitation wavelength, on a second layer (b) with lower refractive index than layer (a), also transparent at least at said excitation wavelength, and at least one grating structure (c) modulated in layer (a), wherein the intensity of an excitation light irradiated at the resonance angle for incoupling into layer (a) is enhanced by at least a factor of 100 on layer (a) and within layer (a), at least in the region of the grating structure (c), in comparison with the intensity of said excitation light on a substrate surface without incoupling of the excitation light.

For achieving an amplification effect as large as possible, the most important parameters for the design of the grating waveguide structure are the depth of the grating structure (c), as well as the refractive index and the depth of the optical layer (a). Upon optimization of these parameters it is possible, that the intensity of an excitation light irradiated at the resonance angle for incoupling into layer (a) is enhanced by at least a factor of 1 000 or 10 000 or even 100 000 on layer (a) and within layer (a), at least in the region of the grating structure (c), in comparison with the intensity of said excitation light on a substrate surface without incoupling of the excitation light.

As a consequence of this large amplification of an irradiated excitation light intensity by means of a grating waveguide structure according to the invention, the excitation light intensity on layer (a) is sufficiently large to excite luminescence from a molecule located on the surface of layer (a) or at a distance below 200-nm from layer (a) by two-photon absorption.

In contrast to known arrangements for generation of excitation light intensities sufficiently high for two-photon excitation, which generally require focusing of the exciting laser light to a cross section of few micrometers, the structure according to the invention allows for achieving the required intensity densities on large areas, i.e., on an area of the order of several square millimeters to square centimeters. Therefore, such a grating waveguide structure is preferred, which is characterized in that the excitation light intensity on layer (a) is sufficiently large simultaneously on an area of at least 1 mm on said grating waveguide structure to excite luminescence from molecules located on the surface of layer (a) or at a distance below 200·nm from layer (a) by two-photon absorption.

The very high excitation light intensity, especially for enabling a two-photon excitation, is useful for a variety of different applications, for example in biosensorics, as described in more detail below, but also in communications and telecommunications techniques for a fast signal transfer. Especially for application in the last-named fields, it is preferred that the grating waveguide structure comprises means for a signal transfer to an adjacent grating waveguide structure. This can be realized by transmitting a luminescence generated on or in the near-field of layer (a) by two-photon absorption to an adjacent grating waveguide structure upon outcoupling by a grating structure (c).

A signal transfer can, however, also occur within the grating waveguide structure, i.e., within layer (a). Therefore, it is preferred that the structure comprises continuous, unmodulated regions of layer (a), which are preferably arranged in direction of propagation of an excitation light incoupled by a grating structure (c) and guided in layer (a). The structure can especially be designed in such a way, that it comprises a multitude of grating structures (c) with identical or different period, optionally adjacent thereto with continuous, unmodulated regions of layer (a) on a common, continuous substrate. Thus, it is also possible, that a luminescence generated on or in the near-field of layer (a) by two-photon absorption, is coupled at least partially into layer (a) and is propagated to adjacent regions of said grating waveguide structure by guiding in layer (a).

For applications in communication techniques such an embodiment of the grating waveguide structure according to the invention is preferred, which is characterized in that the intensity of the excitation light on layer (a) and within layer (a) is sufficiently high, at least in the region of the grating structure (c), for switching the transmission properties of the grating structure (c) for a light signal guided in layer (a). Basis of the switching effect is, that the high light intensity and field strength, in this case within layer (a), are sufficient to change the transmission properties of a grating waveguide structure according to the invention, which is provided in this case as a “Bragg grating” with the characteristic properties described above. As a special advantage, such a grating waveguide structure according to the invention allows for switching the transmission properties of the grating structure (c) by means of an excitation light launched from the outside of layer (a) onto said grating structure.

For enabling the switching function of the grating waveguide structure according to the invention, said grating structure (c) is preferably provided as a “Bragg grating”, and the switching function is based on the change of the grating function from transmission to reflection of a light signal guided in layer (a), due to a change of the optical refractive index in the region of the grating structure caused by the amplified excitation light intensity in layer (a).

For certain applications it is desirable to apply excitation light of different wavelengths to the same grating waveguide structure simultaneously or sequentially. Then it can be advantageous, if this structure comprises a superposition of two or more grating structures of different periodicity, with grating lines arranged in parallel or non-parallel, preferably non-parallel, which structure is operable for the incoupling of excitation light of different wavelengths, wherein, in case of two superimposed grating structures their grating lines are preferably arranged perpendicular to each other.

The amount of the propagation losses of a mode guided in an optically waveguiding layer (a) is determined to a large extent by the surface roughness of a support layer located below as well as by the absorption of chromophores that might occur in that carrier layer, which is additionally associated with the risk of luminescence in that carrier, which is undesired for many applications, due to the penetration of the evanescent field of the mode guided in layer (a). Additionally, thermal strain due to different coefficients of thermal expansion of the optically transparent layers (a) and (b) can occur. In case of a chemically sensitive optically transparent layer (b), in case that it consists, for example, of a transparent thermoplastic plastics, it is desirable to prevent the penetration of solvents that might attack layer (b) through micropores that might exist in the optically transparent layer (a).

Therefore it is advantageous, if a further optically transparent layer (b′) with lower refractive index than the one of layer (a) and with a thickness of 5 nm-10 000 nm, preferably of 10 nm-1000 nm, is located between layers (a) and (b) and in contact with layer (a). Upon introduction of this intermediate layer, a variety of tasks can be fulfilled: Reduction of surface roughness below layer (a), reduction of the penetration of the evanescent field of light guided in layer (a) into the one or more layers located below, reduction of thermally induced stress within the grating waveguide structure, chemical isolation of the optically transparent layer (a) from layers located below by sealing of micropores in layer (a) against the layers located below.

The grating structure (c) of the grating waveguide structure according to the invention can be a diffractive grating with a uniform period or a multidiffractive grating. The grating structure (c) can also be provided with a laterally varying periodicity, perpendicular or in parallel to the direction of propagation of the excitation light coupled into the optically transparent layer (a).

It is preferred that the material of the second optically transparent layer (b) of the grating waveguide structure according to the invention comprises glass, quartz or a transparent thermoplastic or moldable plastics, for example from the group formed by polycarbonate, polyimide or poly methymethacrylate. Further examples of suitable plastics are polystyrene, polyethylene, polyethylene terephtalate, polypropylene or polyurethane and their derivatives.

It is further preferred that the refractive index of the first optically transparent layer (a) is larger than 1.8. A variety of materials are suitable for the optically transparent layer (a). It is preferred, without limiting generality, that the first optically transparent layer (a) comprises a material of the group of TiO₂, ZnO, Nb₂O₅, Ta₂O₅, HfO₂, or ZrO₂, especially preferred of TiO₂ or Nb₂O₅ or Ta₂O₅, or of a material with high third-order nonlinearity of the refractive index, such as poly diacetylene, poly toluenesulfonate or poly phenylenevinylene.

Besides the refractive index of the waveguiding optically transparent layer (a), its thickness is the second important parameter for the generation of an evanescent field as strong as possible at the interfaces to adjacent layers with lower refractive index, and for generation of an energy density as high as possible within layer (a). With decreasing thickness of the waveguiding layer (a), the strength of the evanescent field increases, as long as the layer thickness is sufficient for guiding at least one mode of the excitation wavelength. Thereby, the minimum “cut-off” layer thickness for guiding a mode is dependent on the wavelength of this mode. The “cut-off” layer thickness is larger for light of longer wavelength than for light of shorter wavelength. Approaching the “cut-off” layer thickness, however, also unwanted propagation losses increase strongly, thus setting additionally a lower limit for the choice of the preferred layer thickness. Preferred are layer thicknesses of the optically transparent layer (a) allowing for guiding only one to three modes at a given excitation wavelength. Especially preferred are layer thicknesses resulting in monomodal waveguides for this given excitation wavelength. It is understood that the character of discrete modes of the guided light does only refer to the transversal modes.

Resulting from these requirements, the product of the thickness of layer (a) and of its refractive index is preferably between one tenth and a whole, most preferably between one third and two thirds, of the excitation wavelength of the excitation light to be coupled into layer (a).

For given refractive indices of the waveguiding, optically transparent layer (a) and of the adjacent layers, the resonance angle for incoupling of the excitation light, according to the above mentioned resonance condition, is dependent on the diffraction order to be incoupled, on the excitation wavelength and on the grating period. Incoupling of the first diffraction order is advantageous for increasing the incoupling efficiency. Besides the number of the diffraction order, the grating depth is important for the amount of the incoupling efficiency. As a matter of principle, the coupling efficiency increases with increasing grating depth. The process of outcoupling being completely reciprocal to the incoupling, however, the outcoupling efficiency increases simultaneously, resulting in an optimum for the excitation of luminescence in a measurement area (d) (according to the definition below) located on or adjacent to the grating structure (c), the optimum being dependent on the geometry of the measurement areas and of the launched excitation light bundle. Based on these boundary conditions, it is advantageous, if the grating (c) has a period of 200 nm-1000 nm and a modulation depth of 3 nm-100 nm, preferably of 10 nm-30 nm.

Furtheron, it is preferred that the ratio of the modulation depth of the grating to the thickness of the first optically transparent layer (a) is equal or smaller than 0.2.

Thereby, the grating structure (c) can be a relief grating with a rectangular, triangular or semi-circular profile or a phase or volume grating with a periodic modulation of the refractive index in the essentially planar, optically transparent layer (a).

Furtheron, it can be advantageous, if optically or mechanically recognizable marks for simplifying adjustments in an optical system and/or for the connection to sample compartments as part of an analytical system are provided on said structure.

The grating waveguide structure according to the invention is especially suited for application in biochemical analytics, for the highly sensitive detection of one or more analytes in one or more supplied samples. The following group of preferences is mainly directed to this field of applications. For these applications, biological or biochemical or synthetic recognition elements, for recognition and binding of analytes to be determined, are immobilized on the grating waveguide structure. The immobilization can be performed on large surfaces, possibly over the whole structure, or in discrete so-called measurement areas.

In the spirit if this invention, laterally separated measurement areas (d) shall be defined by the area that is occupied by biological or biochemical or synthetic recognition elements immobilized thereon, for recognition of one or multiple analytes in a liquid sample. These areas can have any geometry, for example the form of dots, circles, rectangles, triangles, ellipses or lines. It is possible that up to 1 000 000 measurement areas are provided in a two-dimensional arrangement on a grating waveguide structure according to the invention, wherein a single measurement area can occupy, for example, an area of 0.001 mm²-6 mm². Within a given measurement area, identical recognition elements, for recognition and binding respectively determination of a single analyte, or also different recognition elements, for recognition of different analytes, can be immobilized. As recognition elements also such compounds can be applied, which are provided with several (i.e. two or more) different ranges or segments to which different analytes can be bound.

For example, in case of a planar thin-film waveguide with one or more grating structures (c) for the incoupling of excitation light as the grating waveguide structure, the measurement areas can be arranged on such a grating structure or on a continuous, unmodulated region located after such a grating structure, with respect to the direction of propagation of the guided excitation light.

In order to determine multiple analytes in a sample simultaneously, it can be advantageous, if two or more laterally separated measurement areas are combined to segments on the grating waveguide structure. Different segments can be separated from one another, especially optically if a cross-talk of luminescence generated in adjacent segments and back-coupled into layer (a) shall be prevented, by grating structures (c) or by other separations generated on the grating waveguide structure, such as absorbing strips of an deposited pigment or by the separating walls of structures for generation of sample compartments having the grating waveguide structure as the bottom surface. Different segments can additionally be separated from each other by a deposited rim supporting the fluidic sealing between adjacent areas and/or contributing to a reduction of the optical cross-talk between adjacent areas.

There are many methods for the deposition of the biological or biochemical or synthetic recognition elements on the optically transparent layer (a). For example, the deposition can be performed by physical adsorption or electrostatic interaction. In general, the orientation of the recognition elements is then of statistic nature. Additionally, there is the risk of washing away a part of the immobilized recognition elements, if the sample containing the analyte and reagents applied in the analysis process have a different composition. Therefore, it can be advantageous, if an adhesion-promoting layer (f) is deposited on the optically transparent layer (a), for immobilization of biological or biochemical or synthetic recognition elements (e). This adhesion-promoting layer should be transparent as well. In especial, the thickness of the adhesion-promoting layer should not exceed the penetration depth of the evanescent field out of the waveguiding layer (a) into the medium located above. Therefore, the adhesion-promoting layer (a) should have a thickness of less than 200 nm, preferably of less than 20 nm. The adhesion-promoting layer can comprise, for example, chemical compounds of the group comprising silanes, epoxides, functionalized, charged or polar polymers, and “self-organized functionalized monolayers”.

As stated in the definition of the measurement areas, laterally separated measurement areas (d) can be generated by laterally selective deposition of biological or biochemical or synthetic recognition elements on the grating waveguide structure. When brought into contact with an analyte capable of luminescence or with a luminescently marked analogue of the analyte competing with the analyte for the binding to the immobilized recognition elements or with a further luminescently marked binding partner in a multi-step assay, these molecules capable of luminescence will bind to the surface of the sensor platform selectively only in the measurement areas, which are defined by the areas occupied by the immobilized recognition elements.

For the deposition of the biological or biochemical or synthetic recognition elements one or more methods of the group of methods comprising ink jet spotting, mechanical spotting, micro contact printing, fluidic contacting of the measurement areas with the biological or biochemical or synthetic recognition elements upon their supply in parallel or crossed micro channels, upon application of pressure differences or electric or electromagnetic potentials, can be applied. Components of the group comprising, for example, nucleic acids (e.g. DNA, RNA, oligonucleotides), nucleic acid analogues (e.g. PNA), antibodies, aptamers, membrane-bound and isolated receptors, their ligands, antigens for antibodies, “histidin-tag components”, cavities generated by chemical synthesis, for hosting molecular imprints. etc., can be deposited as biological or biochemical or synthetic recognition elements.

With the last-named type of recognition elements are meant cavities, that are produced by a method described in the literature as “molecular imprinting”. In this procedure, the analyte or an analyte-analogue, mostly in organic solution, is encapsulated in a polymeric structure. Then it is called an “imprint”. Then the analyte or its analogue is dissolved from the polymeric structure upon addition of adequate reagents, leaving an empty cavity in the polymeric structure. This empty cavity can then be used as a binding site with high steric selectivity in a later method of analyte determination.

Of course also any other compound, which selectively recognizes an analyte to be determined and interacts with it, according to the desired and required selectivity for the application under consideration, is suited as a recognition element.

Also whole cells or cell fragments can be deposited as biological or biochemical or synthetic recognition elements.

In many cases the detection limit of an analytical method is limited by signals caused by so-called nonspecific binding, i.e. by signals caused by the binding of the analyte or of other components applied for analyte determination, which are not only bound in the area of the provided immobilized biological or biochemical or synthetic recognition elements, but also in areas of a sensor platform that are not occupied by these recognition elements, for example upon hydrophobic adsorption or electrostatic interactions. Therefore, it is advantageous, if compounds, that are “chemically neutral” towards the analyte, are deposited between the laterally separated measurement areas (d), in order to minimize nonspecific binding or adsorption. As “chemically neutral” compounds such components are called, which themselves do not have specific binding sites for the recognition and binding of the analyte or of an analogue of the analyte or of a further binding partner in a multistep assay and which prevent, due to their presence, the access of the analyte or of its analogue or of the further binding partners to the surface of the sensor platform.

Compounds of the groups formed by albumins, especially bovine serum albumin or human serum albumin, fragmented natural or synthetic DNA not hybridizing with polynucleotides to be analyzed, such as herring or salmon sperm, or also uncharged but hydrophilic polymers, such as poly ethyleneglycols or dextranes, can, for example, be applied as “chemically neutral” compounds.

Especially the selection of the mentioned compounds for a reduction of nonspecific hybridization is polynucleotide hybridization assays (such as herring or salmon sperm) is thereby determined by the empirical preference for DNA as different as possible from the polynucleotides to be analyzed, about which no interaction with the polynucleotide sequences to be analyzed is known.

A further subject of the invention is an optical system for amplification of the intensity of an excitation light, comprising at least one excitation light source and a grating waveguide structure according to the invention, wherein the intensity of an excitation light irradiated at the resonance angle for incoupling into layer (a) is enhanced by at least a factor of 100 on layer (a) and within layer (a), at least in the region of the grating structure (c), in comparison with the intensity of said excitation light on a substrate surface without incoupling of the excitation light.

As described above, the amplification factor can still be increased significantly, especially upon optimization of the physical parameters of the grating waveguide structure. Therefore, preferred embodiments of the optical system according to the invention comprise such embodiments, by means of which the intensity of an excitation light irradiated at the resonance angle for incoupling into layer (a) is enhanced by at least a factor of 1 000 or 10 000 or even 100 000 on layer (a) and within layer (a), at least in the region of the grating structure (c), in comparison with the intensity of said excitation light on a substrate surface without incoupling of the excitation light.

Preferred are such embodiments of the optical system, which are characterized in that the excitation light intensity on layer (a) is sufficiently large to excite luminescence from a molecule located on layer (a) or at a distance below 200-nm from layer (a) by two-photon absorption. It is especially preferred, if the excitation light intensity on layer (a) is sufficiently large simultaneously on an area of at least 1 mm² on said grating waveguide structure to excite luminescence from molecules located on the surface of layer (a) or at a distance below 200-nm from layer (a) by two-photon absorption.

For the applications in communication techniques described above, the optical system according to the invention is preferably provided in such an embodiment, that a luminescence generated on or in the near-field of layer (a) by two-photon absorption can be transmitted to an adjacent grating waveguide structure upon outcoupling by a grating structure (c).

For this purpose it can be adequate if the grating waveguide structure, as part of the optical system, comprises continuous, unmodulated regions of layer (a), which are preferably arranged in direction of propagation of an excitation light incoupled by a grating structure (c) and guided in layer (a). It can be especially of advantage, if the grating waveguide structure comprises a multitude of grating structures (c) with identical or different period, optionally adjacent thereto with continuous, unmodulated regions of layer (a) on a common, continuous substrate. Thereby, the optical system is provided, in a preferred embodiment, in such a way that a luminescence generated on or in the near-field of layer (a) by two-photon absorption, is coupled at least partially into layer (a) and is propagated to adjacent regions of said grating waveguide structure by guiding in layer (a).

For application of the optical system according to the invention, it is preferred that the intensity of the excitation light on layer (a) and within layer (a) is sufficiently high, at least in the region of the grating structure (c), for switching the transmission properties of the grating structure (c), being part of the optical system, for a light signal guided in layer (a).

It is of special advantage that the optical system according to the invention, with a grating waveguide structure according to the invention, allows for switching the transmission properties of the grating structure (c) by means of an excitation light launched from the outside of layer (a) onto said grating structure.

Preferably the optical system according to the invention is thereby characterized in that said grating structure (c) is provided as a “Bragg grating”, and the switching function is based on the change of the grating function from transmission to reflection of a light signal guided in layer (a), due to a change of the optical refractive index in the region of the grating structure caused by the amplified excitation light intensity in layer (a).

It is further preferred that the optical system according to the invention comprises at least one detector for the measurement of one or more luminescences from the grating waveguide structure.

For the geometry of the ray guiding of the excitation until its launch on the grating waveguide structure according to the invention, there are a variety of different possible embodiments. One of the preferred embodiments is characterized in that the excitation light emitted from the at least one excitation light source is essentially parallel and irradiated on a grating structure modulated in the optically transparent layer (a) at the resonance angle for incoupling into layer (a).

Characteristic for an especially preferred embodiment is, that the excitation light from at least one light optics is expanded to an essentially parallel ray bundle by an expansion optics and irradiated on a grating structure (c) of macroscopic area modulated in the optically transparent layer (a) at the resonance angle for incoupling into layer (a).

Characteristic for another preferred embodiment is, that the excitation light from the at least one light source is divided into a plurality of individual rays of as uniform as possible intensity by a diffractive optical element, or in case of multiple light sources, by multiple diffractive optical elements, which are preferably Dammann gratings, or by refractive optical elements, which are preferably microlens arrays, the individual rays being launched essentially parallel to each other on grating structures (c) the resonance angle for incoupling into layer (a).

For certain applications it is preferred that two or more light sources of similar or different emission wavelength are used as excitation light sources.

For those applications, where two or more different excitation wavelengths shall be applied, an embodiment of the optical system is preferred, wherein the excitation light from two or more light sources is launched simultaneously or sequentially from different directions on a grating structure (c) and incoupled by that structure into layer (a), said grating structure comprising a superposition of grating structures of different periodicity.

It is preferred to use at least one laterally resolving detector for signal detection, for example from the group formed by CCD cameras, CCD chips, photodiode arrays, avalanche diode arrays, multichannel plates and multichannel photomultipliers.

According to the invention, the optical system comprises such embodiments, wherein optical components of the group formed by lenses or lens systems for the shaping of the transmitted light bundles, planar or curved mirrors for the deviation and optionally additional shaping of the light bundles, prisms for the deviation and optionally spectral separation of the light bundles, dichroic mirrors for the spectrally selective deviation of parts of the light bundles, neutral density filters for the regulation of the transmitted light intensity, optical filters or monochromators for the spectrally selective transmission of parts of the light bundles, or polarization selective elements for the selection of discrete polarization directions of the excitation and/or luminescence light are located between the one or more excitation light sources and the grating waveguide structure according to the invention and/or between said grating waveguide structure and the one or more detectors.

It is also possible that the excitation light is launched in pulses with a duration between 1 fsec and 10 min, and that the emission light from the measurement areas is measured time-resolved.

Furtheron, it is preferred, for referencing purposes, that light signals of the group formed by excitation light at the location of the light sources or after expansion of the excitation light or after its dividing into individual beams, scattered light at the excitation wavelength from the location of the one or more laterally separated measurement areas, and light of the excitation wavelength outcoupled by the grating structure (c) besides the measurement areas are measured. Thereby, it is especially advantageous, if the measurement areas for determination of the emission light and of the reference signal are identical.

Launching of the excitation light and detection of the emission light from one or more measurement areas can also be performed sequentially for one or more measurement areas. This can be put into practice especially upon performing sequential excitation and detection by means of movable optical components of the group formed by mirrors, deviating prisms, and dichroic mirrors.

Subject of the invention is also such an optical system, wherein sequential excitation and detection is performed using an essentially focus and angle preserving scanner. It is also possible, that the grating waveguide structure is moved between steps of sequential excitation and detection.

A further subject of the invention is an analytical system for the determination of one or more analytes in at least one sample on one or more measurement areas on a grating waveguide structure by luminescence detection, comprising an optical film waveguide, comprising
a grating waveguide structure according to the invention
an optical system according to the invention, and
supply means for bringing the one or more samples into contact with the measurement areas grating waveguide structure.

It is preferred, that the analytical system additionally comprises one or more sample compartments, which are at least in the area of the one or more measurement areas or of the measurement areas combined to segments open towards the grating waveguide structure. Thereby, the sample compartments can preferably each have a volume of 0.1 nl-100 μl.

In one possible embodiment, the sample compartments are closed, except for inlet and/or outlet openings for the supply or outlet of samples and optionally of additional reagents, at their side opposite to the optically transparent layer (a), and the supply or the outlet of the samples and optionally of additional reagents is performed in a closed flow through system, wherein, in case of liquid supply to several measurement areas or segments with common inlet and outlet openings, these openings are preferably addressed row by row or column by column.

Characteristic for another possible embodiment is, that the sample compartments have openings for locally addressed supply or removal of samples or other reagents at their side opposite to the optically transparent layer (a).

In a further embodiment, compartments for reagents are provided, which reagents are wetted during the assay for the determination of the one or more analytes and brought into contact with the measurement areas.

A further subject of the invention is a method for amplification of an excitation light intensity, wherein the intensity of an excitation light irradiated at the resonance angle for incoupling into layer (a) on a grating structure (c) modulated in layer (a) of a grating waveguide structure according to the invention is enhanced by at least a factor of 100 on layer (a) and within layer (a), at least in the region of the grating structure (c), in comparison with the intensity of said excitation light on a substrate surface without incoupling of the excitation light.

As described above, the amplification factor can still be enlarged, especially upon optimization of the physical parameters of the grating waveguide structure. Therefore, preferred embodiments of the method according to the invention include such embodiments, wherein the intensity of an excitation light irradiated at the resonance angle for incoupling into layer (a) on a grating structure (c) modulated in layer (a) is enhanced by at least a factor of 1 000 or 10 000 or even 100 000 on layer (a) and within layer (a), at least in the region of the grating structure (c), in comparison with the intensity of said excitation light on a substrate surface without incoupling of the excitation light.

Preferably, the excitation light intensity on layer (a) is sufficiently large to excite luminescence from a molecule located on the surface of layer (a) or at a distance below 200·nm from layer (a) by two-photon absorption. Thereby, it is especially preferred, if the excitation light intensity on layer (a) is sufficiently large simultaneously on an area of at least 1 mm² on said grating waveguide structure to excite luminescence from molecules located on the surface of layer (a) or at a distance below 200-nm from layer (a) by two-photon absorption.

For the applications in communication or telecommunication techniques mentioned above, such embodiments of the method according to the invention are preferred, wherein a luminescence generated on or in the near-field of layer (a) by two-photon absorption is transmitted to an adjacent grating waveguide structure upon outcoupling by a grating structure (c).

For this purpose it can be suitable, if the grating waveguide structure comprises continuous, unmodulated regions of layer (a), which are preferably arranged in direction of propagation of an excitation light incoupled by a grating structure (c) and guided in layer (a). It can be especially advantageous, if the grating waveguide structure comprises a multitude of grating structures (c) with identical or different period, optionally adjacent thereto with continuous, unmodulated regions of layer (a) on a common, continuous substrate. Thereby in a preferred embodiment of the method, the optical system is designed in such a way that a luminescence generated on or in the near-field of layer (a) by two-photon absorption, is coupled at least partially into layer (a) and is propagated to adjacent regions of said grating waveguide structure by guiding in layer (a).

A further subject of the invention is a method for the detection of one or more analytes by luminescence detection, in one or more samples on one or more measurement areas of a grating waveguide structure according to the invention, for the determination of one or more luminescences from a measurement area or from an array of at least two or more laterally separated measurement areas (d) or of at least two or more laterally separated segments comprising several measurement areas on said grating waveguide structure, wherein the intensity of an excitation light irradiated at the resonance angle for incoupling into layer (a) is enhanced by at least a factor of 100 on layer (a) and within layer (a), at least in the region of the grating structure (c), in comparison with the intensity of said excitation light on a substrate surface without incoupling of the excitation light.

Again, preferred variants of the method according to the invention include such embodiments, wherein the intensity of an excitation light irradiated at the resonance angle for incoupling into layer (a) is enhanced by at least a factor of 1 000 or 10 000 or even 100 000 on layer (a) and within layer (a), at least in the region of the grating structure (c), in comparison with the intensity of said excitation light on a substrate surface without incoupling of the excitation light.

It is especially preferred, if the excitation light intensity on layer (a) is sufficiently large to excite luminescence from a molecule located on the surface of layer (a) or at a distance below 200-nm from layer (a) by two-photon absorption. Thereby, its especially preferred, if the excitation light intensity on layer (a) is sufficiently large simultaneously on an area of at least 1 mm² said grating waveguide structure to excite luminescence from molecules located on the surface of layer (a) or at a distance below 200-nm from layer (a) by two-photon absorption.

For applications in communication techniques such an embodiment of the method according to the invention is preferred, wherein the intensity of the excitation light on layer (a) and within layer (a) is sufficiently high, at least in the region of the grating structure (c), for switching the transmission properties of the grating structure (c) for a light signal guided in layer (a).

It is a special advantage of this method, that it allows for switching the transmission properties of the grating structure (c) by means of an excitation light launched from the outside of layer (a) onto said grating structure.

Thereby, such an embodiment of the method according to the invention is preferred, which is characterized in that wherein said grating structure (c) is provided as a “Bragg grating”, and the switching function is based on the change of the grating function from transmission to reflection of a light signal guided in layer (a), due to a change of the optical refractive index in the region of the grating structure caused by the amplified excitation light intensity in layer (a).

Characteristic for a specially preferred embodiment of this method is, that a first excitation light as a signal light, in the form of temporal pulse or continuously, is coupled into layer (a) by a first grating structure and is guided in layer (a), until said incoupled, guided signal light arrives in the region of another grating structure (c′) structured in layer (a), with the same or a grating period different from the one of said first grating structure (c), an excitation light irradiated from externally, as a switching light in the form of a temporal pulse or continuously, being incoupled into layer (a) by means of said second grating structure, and, due to the associated amplification of this switching light by at least a factor of 100 on layer (a) and within layer (a) at least in the region of the grating structure, in comparison with the intensity of this excitation light on a substrate surface without incoupling of the excitation light, the refractive index of layer (a) is changed at least in the region of grating structure (c′), due to high third-order nonlinearity, so that the function of said grating structure (c′) is changed from transmission to reflection of said signal light.

For the methods for luminescence detection described above it is possible, that (1) the isotropically emitted luminescence or (2) the luminescence that is coupled back into the optically transparent layer (a) and outcoupled by grating structures (c) or luminescences of both parts (1) and (2) simultaneously are measured.

For the generation of luminescence or fluorescence, in the method according to the invention, a luminescence or fluorescence label can be used, which can be excited and emits at a wavelength between 200 nm and 1100 nm.

The luminescence or fluorescence labels can be conventional luminescence or fluorescence dyes or also luminescent or fluorescent nanoparticles, based on semiconductors (W. C. W. Chan and S. Nie, “Quantum dot bioconjugates for ultrasensitive nonisotopic detection”, Science 281 (1998) 2016-2018).

It is preferred that said luminescence label is excited by two-photon absorption. Thereby, its is especially preferred that said luminescence label is excited to an ultraviolet or blue luminescence by two-photon absorption of an excitation light in the visible or near infrared.

The luminescence label can be bound to the analyte or, in a competitive assay, to an analyte analogue or, in a multi-step assay, to one of the binding partners of the immobilized biological or biochemical or synthetic recognition elements or to the biological or biochemical or synthetic recognition elements.

Additionally, a second or more luminescence labels of similar or different excitation wavelength as the first luminescence label and similar or different emission wavelength can be used. Thereby, it can be advantageous, if the second or more luminescence labels can be excited at the same wavelength as the first luminescence label, but emit at other wavelengths.

For other applications, it can be advantageous, if the excitation and emission spectra of the applied luminescent dyes do not or only partially overlap.

In the method according to the invention, it can be further advantageous, if charge or optical energy transfer from a first luminescent dye acting as a donor to a second luminescent dye acting as an acceptor is used for the detection of the analyte.

Additionally, it can be advantageous, if the one or more luminescences and/or determinations of light signals at the excitation wavelengths are performed polarization-selective. Furtheron, the method allows for measuring the one or more luminescences at a polarization that is different from the one of the excitation light.

A special embodiment of the method for determination of one or more analytes by luminescence detection, according to the invention, is based on the ability to excite native fluorescence (“autofluorescence”) of biomolecules capable of fluorescence, such as trytophane, which are located on the surface of layer (a) or at a distance of less than 200 nm from layer (a), by two-photon absorption. Tryptophane, for example, has an absorption maximum at 280 nm. Therefore, an excitation of the tryptophane fluorescence is typically not possible by a classical one-photon absorption process in the evanescent field of a high-refractive waveguide, as excitation light of such short wavelength is not guided over significant distance in the waveguide, but absorbed or scattered out. Following the method according to the invention, however, it is possible to apply excitation light of adequate longer wavelength for a two-photon absorption process, which is guided in the waveguiding layer (a) over longer distances, and thus excite the short-wavelength fluorescence. As a special advantage, this variant of the method does not require the chemical association of the analyte or of one of its binding partners in a determination method with a luminescence label. Instead of that, the determination can be based directly on the detection of biological compounds capable of luminescence, which are occurring as a natural part of these compounds, or which are inserted into the analyte or into one of its binding partners in a biological production process.

Characteristic for a special variant of the method according to the invention is, molecules located on the surface of layer (a) or at distance of less than 200 nm from layer (a) are trapped within this distance, due to the large amplification of an irradiated excitation light on layer (a) and within layer (a), as the high surface-confined excitation light intensity and its increasing gradient in direction towards the surface exposes these molecules to the effect of an “optical tweezers”.

The method according to the invention allows for the simultaneous or sequential, quantitative or qualitative determination of one or more analytes of the group comprising antibodies or antigens, receptors or ligands, chelators or “histidin-tag components”, oligonucleotides, DNA or RNA strands, DNA or RNA analogues, enzymes, enzyme cofactors or inhibitors, lectins and carbohydrates.

The samples to be examined can be naturally occurring body fluids, such as blood, serum, plasma, lymph or urine or egg yolk.

A sample to be examined can also be an optically turbid liquid, surface water, a soil or plant extract or a bio- or process broth.

The samples to be examined can also be taken from biological tissue pieces.

A further subject of this invention is the use of a grating/waveguide structure according to the invention and/or of an optical system according to the invention and/or of a method according to the invention, each according to any of the embodiments described above, for the determination of chemical, biochemical or biological analytes in screening methods in pharmaceutical research, combinatorial chemistry, clinical and preclinical development, for real-time binding studies and the determination of kinetic parameters in affinity screening and in research, for qualitative and quantitative analyte determinations, especially for DNA- and RNA analytics, for the generation of toxicity studies and the determination of expression profiles and for the determination of antibodies, antigens, pathogens or bacteria in pharmaceutical product development and research, human and veterinary diagnostics, agrochemical product development and research, for patient stratification in pharmaceutical product development and for the therapeutic drug selection, for the determination of pathogens, nocuous agents and germs, especially of salmonella, prions and bacteria, in food and environmental analytics.

A further subject of the invention is the use of a grating waveguide structure according to the invention and/or of an optical system according to the invention and/or of a method according to the invention in nonlinear optics or telecommunication or communication techniques.

Quite in general, a grating waveguide structure according to the invention and/or of an optical system according to the invention and/or of an analytical system according to the invention and/or of a method according to the invention are also suitable for surface-confined investigations which require the application of very high excitation light intensities and/or excitation durations, such as studied of photostabilities of materials, photocatalytic processes etc.

The invention will be further explained and demonstrated in the following example.

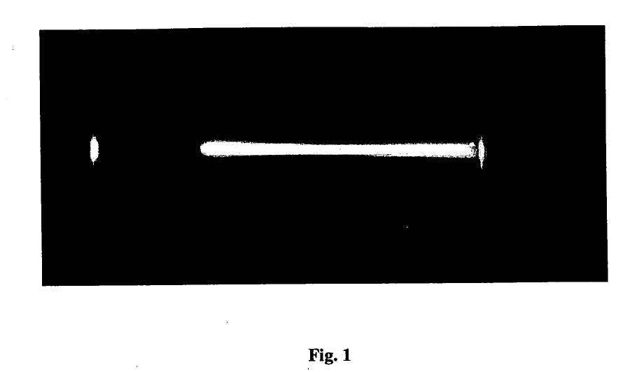

FIG. 1 shows a CCD-camera image of a fluorescence that is visible by naked eye and generated after two-photon excitation by means of a waveguide structure according to the invention.

### EXAMPLE 1

### 1. Waveguide Structure for Two-Photon Excitation of a Luminescence

The waveguide structure consists of a glass substrate (AF45 glass as optical layer (b), n=1.496 at 800 nm) with a 150 nm thin layer (a) of tantalum pentoxide (waveguiding layer (a), n=2.092 at 800 nm). Coupling gratings in the form of relief gratings generated in layer (a) at a spacing of 9 mm (grating period 360 nm, grating depth 12 nm) are used for the in- and outcoupling of light into respectively out of layer (a). Under these conditions, the incoupling angle, in direction from the glass substrate (optical layer (b), n=1.496 at 810 nm) towards the waveguiding layer (a) is −20.4°; the external launching angle onto layer (a) (measured against the normal of the waveguide structure) amounts to −31.4°.

For generation and demonstration of the suitability of this waveguide structure for a 2-photon excitation, a drop of 0.5 μl of a solution of rhodamine in ethanol (15.9 μM rhodamine B in ethanol) is deposited between two grating structures on layer (a), such that the rhodamine molecules, as examples of molecules capable of luminescence, remain on layer (a) after evaporation of the ethanol.

### 2. Optical System for Two-Photon Luminescence Excitation, Process of Measurement for Two-Photon Luminescence Excitation and Results

A pulsed titanium sapphire laser emitting around 800 nm (pulse length: 100 fs; repetition rate: 80 MHz, applied average power: up to 0.6 W, spectral pulse width: 8 nm) is used as the excitation light source. The intensity of the excitation light emitted by the laser can be regulated continuously between 0% and 100% of the original power using an electro-optical modulator.

Lenses can be inserted into the excitation light path after the electro-optical modulator (in direction towards the waveguide structure), in order to generate parallel launched excitation light bundles of a desired geometry on the incoupling grating (c) of the waveguide structure. The launched excitation light is directed towards the incoupling grating (c) of the waveguide structure using a mirror mounted on an adjustment component allowing for translation in x-, y-, and z-direction (in parallel and perpendicular to the grating lines) and for rotation (with a rotation axis that is identical with the grating lines of the incoupling grating).

At a launched average power of 0.5 W, a collimated beam is directed onto the incoupling grating at the resonance angle for incoupling. Therefore, the beam is slightly focused by a lens (f·=·12.7·cm), with the incoupling grating (plane of the waveguide structure) being located in the “beam waist”, where the excitation light thus arrives as a planar wave. In the region of the immobilized luminescence dye, along the mode guided in the waveguide structure, a two-photon fluorescence such strong is excited, that it can be observed even by naked eye under room light (FIG. 1, taken with an IR discriminating filter (BG39)). The bright light spot on the left indicates the position of incoupling of the excitation light on the incoupling grating. Because of the extraordinarily high amplification of the excitation light on layer (a) and the additional scattering occurring at the grating structure (c) (incoupling grating), the intensity of the scattered excitation light is strong enough that it is recorded by the camera in spite of its decreasing sensitivity at long wavelengths. The incoupled mode (at a wavelength of 800 nm) is propagated from left to right in the image plane. Before reaching the region where the rhodamine dye is immobilized, the guided mode is invisible. Then, in further direction of mode propagation towards the right, the fluorescence of the rhodamine dye generated by two-photon excitation, is clearly visible. The observed light trace corresponds to a length of 8 mm, until the next grating structure, where the guided excitation light is outcoupled again. Along the whole distance, a significant attenuation of the guided light, respectively of the excited two-photon fluorescence, cannot be observed.

### EXAMPLE 2

### Optical System for Two-Photon Excitation

A high-power laser diode with an emission wavelength of 810 nm (fiber-coupled; 10 W) is used as an excitation light source. By means of a beam-shaping optics located behind the fiber (in direction of light propagation), a parallel excitation light bundle of desired geometry is generated and irradiated onto the grating (grating period 360 nm, grating depth 12 nm) at the coupling angle for incoupling into the waveguiding layer (a) of the grating waveguide structure. The incoupling angle in the glass substrate (optical layer (b), n=1.496 at 810 nm) is −21.7°, the external launching angle −34.1°. The waveguiding layer (a) is 150 nm tantalum pentoxide (n=2.09 at 810 nm). Using these parameters, a fraction of 24% can be coupled into layer (a), and the excitation light intensity at the surface of layer (a) is sufficient for a two-photon excitation.

1-60. (canceled)

61. A method for amplification of an excitation light intensity, using a grating wave guide structure comprising a layer (a), transparent at least at one excitation wavelength, on a second layer (b) with lower refractive index than layer (a), also transparent at least at said excitation wavelength, and at least one grating structure (c) modulated in layer (a), wherein:
a. the refractive index of the first optically transparent layer (a) is larger than 1.8,
b. grating structures (c) modulated in layer (a) have a period of 200 nm-1000 nm and a modulation depth of 3 nm to 100 nm,
c. layer thickness of the optically transparent layer (a) allows guiding of one to three modes at a given wavelength
wherein the intensity of an excitation light irradiated at the resonance angle for incoupling into layer (a) on a grating structure (c) modulated in layer (a) of a grating waveguide structure, is enhanced by at least a factor of 100 on layer (a) and within layer (a), at least in the region of the grating structure (c), in comparison with the intensity of said excitation light on a substrate surface without incoupling of the excitation light and wherein luminescence label or biomolecules capable of luminescence are excited by two-photon absorption.

62. The method according to claim 61, wherein the intensity of an excitation light irradiated at the resonance angle for incoupling into layer (a) on a grating structure (c) modulated in layer (a) is enhanced by at least a factor of 1 000 on layer (a) and within layer (a), at least in the region of the grating structure (c), in comparison with the intensity of said excitation light on a substrate surface without incoupling of the excitation light.

63. The method according to claim 61, wherein the intensity of an excitation light irradiated at the resonance angle for incoupling into layer (a) on a grating structure (c) modulated in layer (a) is enhanced by at least a factor of 10 000 on layer (a) and within layer (a), at least in the region of the grating structure (c), in comparison with the intensity of said excitation light on a substrate surface without incoupling of the excitation light.

64. The method according to claim 61, wherein the intensity of an excitation light irradiated at the resonance angle for incoupling into layer (a) on a grating structure (c) modulated in layer (a) is enhanced by at least a factor of 100 000 on layer (a) and within layer (a), at least in the region of the grating structure (c), in comparison with the intensity of said excitation light on a substrate surface without incoupling of the excitation light.

65. The method according to claim 61, wherein the excitation light intensity on layer (a) is sufficiently large to excite luminescence from a molecule located on the surface of layer (a) or at a distance below 200·nm from layer (a) by two-photon absorption.

66. The method according to claim 65, wherein the excitation light intensity on layer (a) is sufficiently large simultaneously on an area of at least 1 mm² on said grating waveguide structure to excite luminescence from molecules located on the surface of layer (a) or at a distance below 200·nm from layer (a) by two-photon absorption.

67. The method according to claim 61, wherein a luminescence generated on or in the near-field of layer (a) by two-photon absorption is transmitted to an adjacent grating waveguide structure upon outcoupling by a grating structure (c).

68. The method according to claim 61, wherein the grating waveguide structure comprises continuous, unmodulated regions of layer (a), which are preferably arranged in direction of propagation of an excitation light incoupled by a grating structure (c) and guided in layer (a).

69. The method according to claim 61, wherein the grating waveguide structure comprises a multitude of grating structures (c) with identical or different period, optionally adjacent thereto with continuous, unmodulated regions of layer (a) on a common, continuous substrate.

70. The method according to claim 61, wherein a luminescence generated on or in the near-field of layer (a) by two-photon absorption, is coupled at least partially into layer (a) and is propagated to adjacent regions of said grating waveguide structure by guiding in layer (a).

71. The method according to claim 61, wherein the intensity of the excitation light on layer (a) and within layer (a) is sufficiently high, at least in the region of the grating structure (c), for switching the transmission properties of the grating structure (c) for a light signal guided in layer (a).

72. The method according to claim 71, characterized in that it allows for switching the transmission properties of the grating structure (c) by means of an excitation light launched from the outside of layer (a) onto said grating structure.

73. The method according to claim 71, wherein said grating structure (c) is provided as a “Bragg grating”, and the switching function is based on the change of the grating function from transmission to reflection of a light signal guided in layer (a), due to a change of the optical refractive index in the region of the grating structure caused by the amplified excitation light intensity in layer (a).

74. The method according to claim 71, wherein a first excitation light as a signal light, in the form of temporal pulse or continuously, is coupled into layer (a) by a first grating structure and is guided in layer (a), until said incoupled, guided signal light arrives in the region of another grating structure (c′) structured in layer (a), with the same or a grating period different from the one of said first grating structure (c), an excitation light irradiated from externally, as a switching light in the form of a temoral pulse or continuously, being incoupled into layer (a) by means of said second grating structure, and, due to the associated amplification of this switching light by at least a factor of 100 on layer (a) and within layer (a) at least in the region of the grating structure, in comparison with the intensity of this excitation light on a substrate surface without incoupling of the excitation light, the refractive index of layer (a) is changed at least in the region of grating structure (c′), due to high third-order nonlinearity, so that the function of said grating structure (c′) is changed from transmission to reflection of said signal light.

75. A method for the detection of one or more analytes by luminescence detection, in one or more samples on one or more measurement areas of a grating waveguide structure comprising a layer (a), transparent at least at one excitation wavelength, on a second layer (b) with lower refractive index than layer (a), also transparent at least at said excitation wavelength and at least one grating structure (c) modulated in layer (a), wherein:
d. the refractive index of the first optically transparent layer (a) is larger than 1.8,
e. grating structures (c) modulated in layer (a) have a period of 200 nm-1000 nm and a modulation depth of 3 nm to 100 nm,
f. layer thickness of the optically transparent layer (a) allows guiding of one to three modes at a given wavelength
for the determination of one or more luminescences from a measurement area or from an array of at least two or more laterally separated measurement areas (d) or of at least two or more laterally separated segments comprising several measurement areas on said grating waveguide structure, wherein the intensity of an excitation light irradiated at the resonance angle for incoupling into layer (a) is enhanced by at least a factor of 100 on layer (a) and within layer (a), at least in the region of the grating structure (c), in comparison with the intensity of said excitation light on a substrate surface without incoupling of the excitation light and wherein luminescence label or biomolecules capable of luminescence are excited by two-photon absorption.

76. The method according to claim 75, wherein the intensity of an excitation light irradiated at the resonance angle for incoupling into layer (a) is enhanced by at least a factor of 1 000 on layer (a) and within layer (a), at least in the region of the grating structure (c), in comparison with the intensity of said excitation light on a substrate surface without incoupling of the excitation light.

77. The method according to claim 75, wherein the intensity of an excitation light irradiated at the resonance angle for incoupling into layer (a) is enhanced by at least a factor of 10,000 on layer (a) and within layer (a), at least in the region of the grating structure (c), in comparison with the intensity of said excitation light on a substrate surface without incoupling of the excitation light.

78. The method according to claim 75, wherein the intensity of an excitation light irradiated at the resonance angle for incoupling into layer (a) is enhanced by at least a factor of 100,000 on layer (a) and within layer (a), at least in the region of the grating structure (c), in comparison with the intensity of said excitation light on a substrate surface without incoupling of the excitation light.

79. The method according to claim 75, wherein the excitation light intensity on layer (a) is sufficiently large to excite luminescence from a molecule located on the surface of layer (a) or at a distance below 200·nm from layer (a) by two-photon absorption.

80. The method according to claim 79, wherein the excitation light intensity on layer (a) is sufficiently large simultaneously on an area of at least 1 mm² on said grating waveguide structure to excite luminescence from molecules located on the surface of layer (a) or at a distance below 200·nm from layer (a) by two-photon absorption.

81. The method according to claim 61, wherein (1) the isotropically emitted luminescence or (2) the luminescence that is coupled back into the optically transparent layer (a) and outcoupled by grating structures (c) or luminescences of both parts (1) and (2) simultaneously are measured.

82. The method according to claim 61, wherein, for the generation of luminescence, a luminescence dye or luminescent nanoparticle is used as a luminescence label, which can be excited at a wavelength between 200 nm and 1100 nm.

83. The method according to claim 82, wherein said luminescence label is excited by two-photon absorption.

84. The method according to claim 83, wherein said luminescence label is excited to an ultraviolet or blue luminescence by two-photon absorption of an excitation light in the visible or near infrared.

85. The method according to claim 82, wherein the luminescence label is bound to the analyte or, in a competitive assay, to an analyte analogue or, in a multi-step assay, to one of the binding partners of the immobilized biological or biochemical or synthetic recognition elements or to the biological or biochemical or synthetic recognition elements.

86. The method according to claim 82, wherein a second or more luminescence labels of similar or different excitation wavelength as the first luminescence label and similar or different emission wavelength are used.

87. The method according to claim 86, wherein the second or more luminescence labels can be excited at the same wavelength as the first luminescence dye, but emit at other wavelengths.

88. The method according to claim 86, wherein the excitation and emission spectra of the applied luminescent dyes do not or only partially overlap.

89. The method according to claim 86, wherein charge or optical energy transfer from a first luminescent dye acting as a donor to a second luminescent dye acting as an acceptor is used for the detection of the analyte.

90. The method according to claim 61, wherein the one or more luminescences and/or determinations of light signals at the excitation wavelengths are performed polarization-selective, wherein preferably the one or more luminescences are measured at a polarization that is different from the one of the excitation light.

91. The method according to claim 61, wherein molecules located on the surface of layer (a) or at distance of less than 200 nm from layer (a) are trapped within this distance, due to the large amplification of an irradiated excitation light on layer (a) and within layer (a), as the high surface-confined excitation light intensity and its increasing gradient in direction towards the surface exposes these molecules to the effect of an “optical tweezers”.

92. The method according to claim 61 for the simultaneous or sequential, quantitative or qualitative determination of one or more analytes of the group comprising antibodies or antigens, receptors or ligands, chelators or “histidin-tag components”, oligonucleotides, DNA or RNA strands, DNA or RNA analogues, enzymes, enzyme cofactors or inhibitors, lectins and carbohydrates.

93. The method according to claim 61, wherein the samples to be examined are naturally occurring body fluids, such as blood, serum, plasma, lymph or urine or egg yolk, or optically turbid liquids or surface water or soil or plant extracts or bio- or process broths or are taken from biological tissue pieces.

94. The method according to claim 61 for the determination of chemical, biochemical or biological analytes in screening methods in pharmaceutical research, combinatorial chemistry, clinical and preclinical development, for real-time binding studies and the determination of kinetic parameters in affinity screening and in research, for qualitative and quantitative analyte determinations, especially for DNA- and RNA analytics, for the generation of toxicity studies and the determination of expression profiles and for the determination of antibodies, antigens, pathogens or bacteria in pharmaceutical product development and research, human and veterinary diagnostics, agrochemical product development and research, for patient stratification in pharmaceutical product development and for the therapeutic drug selection, for the determination of pathogens, nocuous agents and germs, especially of salmonella, prions and bacteria, in food and environmental analytics.

95. The method according to claim 61 in nonlinear optics or telecommunication or communication techniques.

96. The method according to claim 61 for surface-confined investigations which require the application of very high excitation light intensities and/or excitation durations, such as studies of photostabilities of materials, photocatalytic processes etc.

97. The method according to claim 75, wherein (1) the isotropically emitted luminescence or (2) the luminescence that is coupled back into the optically transparent layer (a) and outcoupled by grating structures (c) or luminescences of both parts (1) and (2) simultaneously are measured.

98. The method according to claim 75, wherein, for the generation of luminescence, a luminescence dye or luminescent nanoparticle is used as a luminescence label, which can be excited at a wavelength between 200 nm and 1100 nm.

99. The method according to claim 98, wherein said luminescence label is excited by two-photon absorption.

100. The method according to claim 99, wherein said luminescence label is excited to an ultraviolet or blue luminescence by two-photon absorption of an excitation light in the visible or near infrared.

101. The method according to claim 98, wherein the luminescence label is bound to the analyte or, in a competitive assay, to an analyte analogue or, in a multi-step assay, to one of the binding partners of the immobilized biological or biochemical or synthetic recognition elements or to the biological or biochemical or synthetic recognition elements.

102. The method according to claim 98, wherein a second or more luminescence labels of similar or different excitation wavelength as the first luminescence label and similar or different emission wavelength are used.

103. The method according to claim 102, wherein the second or more luminescence labels can be excited at the same wavelength as the first luminescence dye, but emit at other wavelengths.

104. The method according to claim 102, wherein the excitation and emission spectra of the applied luminescent dyes do not or only partially overlap.

105. The method according to claim 102, wherein charge or optical energy transfer from a first luminescent dye acting as a donor to a second luminescent dye acting as an acceptor is used for the detection of the analyte.

106. The method according to claim 75, wherein the one or more luminescences and/or determinations of light signals at the excitation wavelengths are performed polarization-selective, wherein preferably the one or more luminescences are measured at a polarization that is different from the one of the excitation light.

107. The method according to claim 75, wherein molecules located on the surface of layer (a) or at distance of less than 200 nm from layer (a) are trapped within this distance, due to the large amplification of an irradiated excitation light on layer (a) and within layer (a), as the high surface-confined excitation light intensity and its increasing gradient in direction towards the surface exposes these molecules to the effect of an “optical tweezers”.

108. The method according to claim 75 for the simultaneous or sequential, quantitative or qualitative determination of one or more analytes of the group comprising antibodies or antigens, receptors or ligands, chelators or “histidin-tag components”, oligonucleotides, DNA or RNA strands, DNA or RNA analogues, enzymes, enzyme cofactors or inhibitors, lectins and carbohydrates.

109. The method according to claim 75, wherein the samples to be examined are naturally occurring body fluids, such as blood, serum, plasma, lymph or urine or egg yolk, or optically turbid liquids or surface water or soil or plant extracts or bio- or process broths or are taken from biological tissue pieces.

110. The method according to claim 75 for the determination of chemical, biochemical or biological analytes in screening methods in pharmaceutical research, combinatorial chemistry, clinical and preclinical development, for real-time binding studies and the determination of kinetic parameters in affinity screening and in research, for qualitative and quantitative analyte determinations, especially for DNA- and RNA analytics, for the generation of toxicity studies and the determination of expression profiles and for the determination of antibodies, antigens, pathogens or bacteria in pharmaceutical product development and research, human and veterinary diagnostics, agrochemical product development and research, for patient stratification in pharmaceutical product development and for the therapeutic drug selection, for the determination of pathogens, nocuous agents and germs, especially of salmonella, prions and bacteria, in food and environmental analytics.

111. The method according to claim 75 in nonlinear optics or telecommunication or communication techniques.

112. The method according to claim 75 for surface-confined investigations which require the application of very high excitation light intensities and/or excitation durations, such as studies of photostabilities of materials, photocatalytic processes etc.
